(19) United States
(12) Patent Application Publication
(10) Pub. No.: US 2025/0189706 A1
(43) Pub. Date: Jun. 12, 2025

(54) OPTICAL FILTER

(71) Applicant: AGC Inc., Tokyo (JP)

(72) Inventors: Takahiro SAKAGAMI, Shizuoka (JP); Takashi NAGATA, Shizuoka (JP); Kazuhiko SHIONO, Fukushima (JP); Yuichiro ORITA, Fukushima (JP)

(73) Assignee: AGC Inc., Tokyo (JP)

(21) Appl. No.: 19/059,959

(22) Filed: Feb. 21, 2025

Related U.S. Application Data
(63) Continuation of application No. PCT/JP2023/030951, filed on Aug. 28, 2023.

(30) Foreign Application Priority Data
Aug. 31, 2022 (JP) 2022-138365

(51) Int. Cl. G02B 5/20; G02B 1/115

(52) U.S. Cl. CPC G02B 5/208; G02B 1/115

(57) ABSTRACT

An optical filter satisfies: (i-1) an average transmittance T_{450-600(0deg)AVE} is 90% or more, (i-2) an average transmittance T_{550-650(0deg)AVE} is 70% or more, (i-3) an average transmittance T_{550-650(60deg)AVE} is 50% or more, (i-4) an average transmittance T_{700-750(0deg)AVE} is 5% or less, (i-5) in a wavelength of 500 nm to 700 nm, an absolute value of a difference between a wavelength IR_{80(0deg)} and a wavelength IR_{20(0deg)} is 90 nm or less, (i-6) in a wavelength of 500 nm to 700 nm, a wavelength IR_{50(0deg)} and a wavelength IR_{50(60deg)} are both in a wavelength region of 600 nm to 660 nm, and an absolute value of a difference between the wavelength IR_{50(0deg)} and the wavelength IR_{50(60deg)} is 30 nm or less, (i-7) an average transmittance T_{800-1200(0deg)AVE} is 15% or less, and (i-8) an average transmittance T_{1200-1700(0deg)AVE} is 50% or less.

### CROSS-REFERENCE TO RELATED APPLICATIONS

This is a bypass continuation of International Application No. PCT/JP2023/030951 filed on Aug. 28, 2023, and claims priority from Japanese Patent Application No. 2022-138365 filed on Aug. 31, 2022, the entire content of which is incorporated herein by reference.

### TECHNICAL FIELD

The present invention relates to an optical filter that transmits visible light and shields near-infrared light.

### BACKGROUND ART

In an imaging device including a solid state image sensor, in order to satisfactorily reproduce a color tone and obtain a clear image, an optical filter that transmits light in a visible region (hereinafter, also referred to as “visible light”) and shields light in a near-infrared wavelength region (hereinafter, also referred to as “near-infrared light”) is used.

Examples of such an optical filter include various types such as a reflection type filter in which dielectric thin films having different refractive indices are alternately laminated on one surface or both surfaces of a transparent substrate (dielectric multilayer film) and light to be shielded is reflected by utilizing interference of light, an absorption type filter in which light to be shielded is absorbed by using a glass or a dye that absorbs light in a specific wavelength region, and a filter in which a reflection type filter and an absorption type filter are combined.

Patent Literature 1 discloses an optical filter including a glass that absorbs light in a near-infrared ray region.

Patent Literature 2 discloses an optical filter including a glass that absorbs light in a near-infrared ray region and a reflection layer formed of a dielectric multilayer film.

### CITATION LIST

### Patent Literature

Patent Literature 1: JPH06-16451A

Patent Literature 2: WO2014/104370

### SUMMARY OF INVENTION

### Technical Problem

In an optical filter, as a change in transmittance between a transmission region and a shielding region is steeper, both transmittance and shielding properties can be efficiently achieved, which is preferable. In the optical filter disclosed in Patent Literature 1, a steepness of a change in transmittance between the visible light as the transmission region and the near-infrared light as the shielding region is small. The reason for this is considered to be that fluorophosphate glass is used as a near-infrared ray absorbing glass.

In an optical filter utilizing reflection of a dielectric multilayer film such as the optical filter disclosed in Patent Literature 2, an optical thickness of the dielectric multilayer film changes depending on an incident angle of light, and thus there is a concern that a spectral transmittance curve and a spectral reflectance curve change depending on the incident angle. For example, when a captured amount of light in a visible light region is changed at a high incident angle, a problem that image reproducibility is reduced may occur. In particular, with a reduction in height of camera modules in recent years, use under a condition of a high incident angle is assumed, and therefore an optical filter that is hardly affected by an incident angle is required.

In addition to an imaging device using the visible light, a sensing device using laser light having a wavelength of 1,200 nm or more may be mounted. Since the laser light used for sensing is pulsed and of high output, in the case where an imaging device is mounted in the vicinity of a laser emitting unit, laser light that is unintentionally incident as stray light cannot be sufficiently shielded, which may cause a damage to a solid state image sensor of the imaging device or may cause a malfunction. Therefore, there is a demand for an optical filter capable of shielding a wavelength region of 1,200 nm or more in a near-infrared light region.

An object of the present invention is to provide an optical filter having excellent transmittance in the visible light region, a steep change in transmittance from a visible light transmission region to a near-infrared light shielding region, excellent shielding properties in the near-infrared light region, in particular, shielding properties in a wide range also including 1,200 nm to 1,700 nm, and a small change in spectral characteristics even at a high incident

### Solution to Problem

The present invention provides an optical filter having the following configuration.
The optical filter satisfies all of the following spectral characteristics (i-1) to (i-8).
   (i-1) An average transmittance T_{450-600(0deg)AVE} at a wavelength of 450 nm to 600 nm and an incident angle of 0 degrees is 90% or more.
   (i-2) An average transmittance T_{550-650(0deg)AVE} at a wavelength of 550 nm to 650 nm and an incident angle of 0 degrees is 70% or more.
   (i-3) An average transmittance T_{550-650(60deg)AVE} at a wavelength of 550 nm to 650 nm and an incident angle of 60 degrees is 50% or more.
   (i-4) An average transmittance T_{700-750(0deg)AVE} at a wavelength of 700 nm to 750 nm and an incident angle of 0 degrees is 5% or less.
   (i-5) In a wavelength of 500 nm to 700 nm, an absolute value of a difference between a wavelength IR_{80(0deg)} at which a transmittance is 80% at an incident angle of 0 degrees and a wavelength IR_{20(0deg)} at which a transmittance is 20% at an incident angle of 0 degrees is 90 nm or less.
   (i-6) In a wavelength of 500 nm to 700 nm, a wavelength IR_{50(0deg)} at which a transmittance is 50% at an incident angle of 0 degrees and a wavelength IR_{50(60deg)} at which a transmittance is 50% at an incident angle of 60 degrees are both in a wavelength region of 600 nm to 660 nm, and an absolute value of a difference between the wavelength IR_{50(0deg)} and the wavelength IR_{50(60deg)} is 30 nm or less.
   (i-7) An average transmittance T_{800-1200(0deg)AVE} at a wavelength of 800 nm to 1,200 nm and an incident angle of 0 degrees is 15% or less.
   (i-8) An average transmittance T_{1200-1700(0deg)AVE} at a wavelength of 1,200 nm to 1,700 nm and an incident angle of 0 degrees is 50% or less.

### ADVANTAGEOUS EFFECTS OF INVENTION

According to the present invention, it is possible to provide an optical filter having excellent transmittance in the visible light region, a steep change in transmittance from a visible light transmission region to a near-infrared light shielding region, excellent shielding properties in the near-infrared light region, in particular, shielding properties in a wide range also including 1,200 nm to 1,700 nm, and a small change in spectral characteristics even at a high incident

### BRIEF DESCRIPTION OF DRAWINGS

FIG. 1 is a cross-sectional view schematically illustrating an example of an optical filter according to one embodiment.

FIG. 2 is a diagram illustrating spectral transmittance curves of a near-infrared ray absorbing glass.

FIG. 3 is a diagram illustrating a spectral transmittance curve of a resin film of Example 1-1.

FIG. 4 is a diagram illustrating spectral transmittance curves of an optical filter of Example 2-1.

FIG. 5 is a diagram illustrating spectral reflectance curves of the optical filter of Example 2-1.

FIG. 6 is a diagram illustrating spectral transmittance curves of an optical filter of Example 2-2.

FIG. 7 is a diagram illustrating spectral transmittance curves of an optical filter of Example 2-3.

FIG. 8 is a diagram illustrating spectral transmittance curves of an optical filter of Example 2-4.

FIG. 9 is a diagram illustrating spectral transmittance curves of an optical filter of Example 2-5.

### DESCRIPTION OF EMBODIMENTS

Hereinafter, embodiments of the present invention are described.

In the present description, a near-infrared ray absorbing dye may be abbreviated as an “NIR dye”, and an ultraviolet absorbing dye may be abbreviated as a “UV dye”.

In the present description, a compound represented by a formula (I) is referred to as a compound (I). The same applies to compounds represented by other formulae. A dye composed of the compound (I) is also referred to as a dye (I), and the same applies to other dyes. A group represented by the formula (I) is also referred to as a group (I), and the same applies to groups represented by other formulae.

In the present description, an internal transmittance is a transmittance obtained by subtracting an influence of interface reflection from a measured transmittance, which is represented by a formula of {measured transmittance (incident angle of 0 degrees)/(100−reflectance (incident angle of 5 degrees))}×100.

In the present description, a transmittance of, for example, 90% or more in a specific wavelength region means that the transmittance does not fall below 90% in the entire wavelength region, that is, a minimum transmittance in the wavelength region is 90% or more. Similarly, a transmittance of, for example, 1% or less in a specific wavelength region means that the transmittance does not exceed 1% in the entire wavelength region, that is, a maximum transmittance in the wavelength region is 1% or less. The same applies to the internal transmittance. An average transmittance and an average internal transmittance in a specific wavelength region are an arithmetic mean of a transmittance and an internal transmittance per 1 nm in the wavelength region.

Spectral characteristics can be measured by using an ultraviolet-visible spectrophotometer.

In the present description, the word “to” that is used to express a numerical range includes upper and lower limits of the range.

### <Optical Filter>

The optical filter according to the present embodiment satisfies all of the following spectral characteristics (i-1) to (i-8).
(i-1) An average transmittance T_{450-600(0deg)AVE} at a wavelength of 450 nm to 600 nm and an incident angle of 0 degrees is 90% or more.
(i-2) An average transmittance T_{550-650(0deg)AVE} at a wavelength of 550 nm to 650 nm and an incident angle of 0 degrees is 70% or more.
(i-3) An average transmittance T_{550-650(60deg)AVE} at a wavelength of 550 nm to 650 nm and an incident angle of 60 degrees is 50% or more.
(i-4) An average transmittance T_{700-750(0deg)AVE} at a wavelength of 700 nm to 750 nm and an incident angle of 0 degrees is 5% or less.
(i-5) In a wavelength of 500 nm to 700 nm, an absolute value of a difference between a wavelength IR_{80(0deg)} at which a transmittance is 80% at an incident angle of 0 degrees and a wavelength IR_{20(0deg)} at which the transmittance is 20% at an incident angle of 0 degrees is 90 nm or less.
(i-6) In a wavelength of 500 nm to 700 nm, a wavelength IR_{50(0deg)} at which a transmittance is 50% at an incident angle of 0 degrees and a wavelength IR_{50(60deg)} at which a transmittance is 50% at an incident angle of 60 degrees are both in a wavelength region of 600 nm to 660 nm, and an absolute value of a difference between the wavelength IR_{50(0deg)} and the wavelength IR_{50(60deg)} is 30 nm or less.
(i-7) An average transmittance T_{800-1200(0deg)AVE} at a wavelength of 800 nm to 1,200 nm and an incident angle of 0 degrees is 15% or less.
(i-8) An average transmittance T_{1200-1700(0deg)AVE} at a wavelength of 1,200 nm to 1,700 nm and an incident angle of 0 degrees is 50% or less.

The optical filter according to the present embodiment that satisfies all of the spectral characteristics (i-1) to (i-8) has high transmittance of visible light as shown in the characteristic (i-1), and has high shielding properties in a near-infrared light region, in particular, a wide range also including 1,200 nm to 1,700 nm as shown in the characteristics (i-4), (i-7), and (i-8). The optical filter has a steep change in transmittance from a visible light transmission region to a near-infrared light shielding region as shown in the characteristic (i-5), and a small change in spectral characteristics even at a high incident angle as shown in the characteristics (i-2), (i-3), and (i-6).

Satisfying the spectral characteristic (i-1) means that transmittance in a visible light region of 450 nm to 600 nm is excellent.

T_{450-600(0deg)AVE} is preferably 90.5% or more, more preferably 91.0% or more, and still more preferably 95% or more.

The spectral characteristic (i-1) can be achieved, for example, by using a dielectric multilayer film having a low reflectance in the visible light region and by using a near-infrared ray absorbing dye and a near-infrared ray absorbing glass having a high transmittance in the visible light region.

Satisfying the spectral characteristics (i-2) and (i-3) means that a transmittance at the wavelength of 550 nm to 650 nm is maintained high even at a high incident angle.

The average transmittance T_{550-650(0deg)AVE} is preferably 71% or more, more preferably 72% or more, and still more preferably 73% or more.

The average transmittance T_{550-650(60deg)AVE} is preferably 55% or more, more preferably 60% or more, and still more preferably 62% or more.

The spectral characteristics (i-2) and (i-3) can be achieved, for example, by using a dielectric multilayer film having a low reflectance in the visible light region.

Satisfying the spectral characteristic (i-4) means that light-shielding properties in the near-infrared light region having a wavelength of 700 nm to 750 nm are excellent.

The average transmittance T_{700-750(0deg)AVE} is preferably 4.7% or less, more preferably 4.5% or less, further preferably 4.0% or less, still more preferably 3.5% or less, and particularly preferably 3.0% or less.

The spectral characteristic (i-4) can be achieved, for example, by shielding light utilizing absorption characteristics of a near-infrared ray absorbing dye and a near-infrared ray absorbing glass.

Satisfying the spectral characteristic (i-5) means that the change in transmittance from the visible light transmission region to the near-infrared light shielding region is steep. As the change in transmittance is steeper, both the transmittance of visible light and the light-shielding properties of near-infrared light can be achieved.

The absolute value of the difference between the wavelength IR_{80(0deg)} and the wavelength IR_{20(0deg)} is preferably 89 nm or less, more preferably 88 nm or less, still more preferably 85 nm or less, and particularly preferably 80 nm or less.

The spectral characteristic (i-5) can be achieved, for example, by using phosphate glass to be described later as the near-infrared ray absorbing glass.

Satisfying the spectral characteristic (i-6) means that a cutoff band from the visible light transmission region to the near-infrared light shielding region is less likely to shift even at a high incident angle.

The absolute value of the difference between the wavelength IR_{50(0deg)} and the wavelength IR_{50(60deg)} is preferably 25 nm or less, more preferably 20 nm or less, and further preferably 15 nm or less.

The spectral characteristic (i-6) can be achieved, for example, by using a dielectric multilayer film having a low reflectance in the near-infrared light region.

Satisfying the spectral characteristics (i-7) and (i-8) means that light-shielding properties in a near-infrared light region over a wide range of 800 nm or more are excellent.

The average transmittance T_{800-1200(0deg)AVE} is preferably 10% or less, more preferably 7% or less, further preferably 5% or less, still more preferably 4% or less, and particularly preferably 1% or less.

The average transmittance T_{1200-1700(0deg)AVE} is preferably 40% or less, more preferably 35% or less, further preferably 30% or less, still more preferably 25% or less, and particularly preferably 20% or less.

The spectral characteristics (i-7) and (i-8) can be achieved, for example, by using the phosphate glass to be described later as the near-infrared ray absorbing glass.

The optical filter according to the present embodiment includes a dielectric multilayer film 1, a resin film, a near-infrared ray absorbing glass, and a dielectric multilayer film 2 in this order, in which the resin film includes a resin and a near-infrared ray absorbing dye having a maximum absorption wavelength in 690 nm to 800 nm in the resin, and it is preferable that a thickness of the resin film is 10 μm or less. With such a configuration, an optical filter that satisfies all of the spectral characteristics (i-1) to (i-8) is easily obtained.

In the present invention, as to be described later, it is preferable that the light-shielding properties of the optical filter are substantially ensured by the absorption characteristics of the near-infrared ray absorbing glass and the near-infrared ray absorbing dye. Since an influence of an incident angle of light on the absorption characteristics is relatively minor, an optical filter in which a change in spectral characteristics is small even at a high incident angle is obtained.

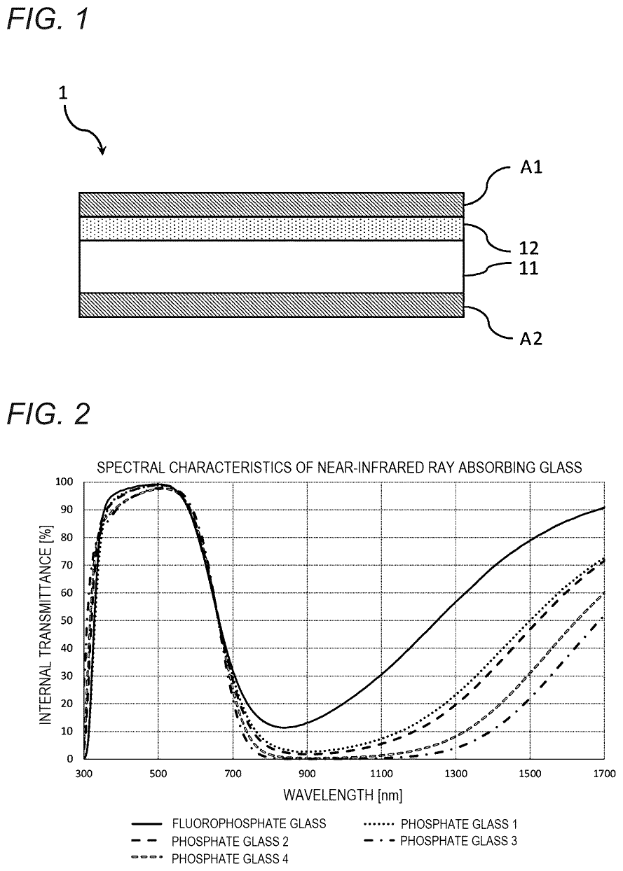

A configuration example of the optical filter according to the present embodiment is described with reference to the drawings. FIG. 1 is a cross-sectional view schematically illustrating an example of an optical filter according to one embodiment.

An optical filter 1 illustrated in FIG. 1 includes a dielectric multilayer film A1, a resin film 12, a near-infrared ray absorbing glass 11, and a dielectric multilayer film A2 in this order.

The optical filter according to the present embodiment preferably further satisfies the following spectral characteristics (i-9) and (i-10).
(i-9) A maximum transmittance T_{750-1200(0deg)MAX} at a wavelength of 750 nm to 1,200 nm and an incident angle of 0 degrees is 30% or less.
(i-10) A maximum transmittance T_{750-1200(60deg)MAX} at a wavelength of 750 nm to 1,200 nm and an incident angle of 60 degrees is 30% or less.

Satisfying the spectral characteristics (i-9) and (i-10) means that the light-shielding properties in a near-infrared ray region having a wavelength of 750 nm to 1,200 nm are excellent even at a high incident angle.

The maximum transmittance T_{750-1200(0deg)MAX} is more preferably 20% or less, further preferably 15% or less, still more preferably 10% or less, particularly preferably 5.0% or less, and most preferably 2.5% or less.

The maximum transmittance T_{750-1200(60deg)MAX} is more preferably 20% or less, further preferably 10% or less, still more preferably 6.0% or less, particularly preferably 5.0% or less, and most preferably 2.5% or less.

The spectral characteristics (i-9) and (i-10) can be achieved, for example, by using the phosphate glass to be described later as the near-infrared ray absorbing glass.

The optical filter according to the present embodiment preferably further satisfies the following spectral characteristics (i-11) to (i-14).
(i-11) An average transmittance T_{450-600(60deg)AVE} at a wavelength of 450 nm to 600 nm and an incident angle of 60 degrees is 80% or more.
(i-12) An absolute value of a difference between the average transmittance T_{450-600(0deg)AVE} and the average transmittance T_{450-600(60deg)AVE} is 10% or less.
(i-13) A maximum transmittance T_{1000-1200(0deg)MAX} at a wavelength of 1,000 nm to 1,200 nm and an incident angle of 0 degrees is 30% or less.
(i-14) A maximum transmittance T_{1000-1200(60deg)MAX} at a wavelength of 1,000 nm to 1,200 nm and an incident angle of 60 degrees is 20% or less.

Satisfying the spectral characteristics (i-11) and (i-12) means that the transmittance of visible light is excellent even at a high incident angle.

The average transmittance T_{450-600(60deg)AVE} is more preferably 81.0% or more, further preferably 81.5% or more, and still more preferably 82.0% or more.

The absolute value of the difference between the average transmittance T_{450-600(0deg)AVE} and the average transmittance T_{450-600(60deg)AVE} is more preferably 9.5% or less, further preferably 9.0% or less, and still more preferably 8.0% or less.

The spectral characteristics (i-11) and (i-12) can be achieved, for example, by using a dielectric multilayer film having a low reflectance in the visible light region and by using a near-infrared ray absorbing dye and a near-infrared ray absorbing glass having a high transmittance in the visible light region.

Satisfying the spectral characteristics (i-13) and (i-14) means that the light-shielding properties in a near-infrared light region having a wavelength of 1,000 nm to 1,200 nm are excellent even at a high incident angle.

The maximum transmittance T_{1000-1200(0deg)MAX} is more preferably 20% or less, further preferably 15% or less, still more preferably 10% or less, particularly preferably 5.0% or less, and most preferably 2.5% or less.

The maximum transmittance T_{1000-1200(60deg)MAX} is more preferably 15% or less, further preferably 10% or less, still more preferably 5.0% or less, particularly preferably 2.5% or less, and most preferably 1.0% or less.

The spectral characteristics (i-13) and (i-14) can be achieved, for example, by using the phosphate glass to be described later as the near-infrared ray absorbing glass.

The optical filter according to the present embodiment preferably further satisfies the following spectral characteristics (i-15) and (i-16).
(i-15) When a dielectric multilayer film 1 side is set as an incident direction, a maximum reflectance R1_{450-600(5deg)MAX} at a wavelength of 450 nm to 600 nm and an incident angle of 5 degrees is 3% or less.
(i-16) When a dielectric multilayer film 2 side is set as an incident direction, a maximum reflectance R2_{450-600(5deg)MAX} at a wavelength of 450 nm to 600 nm and an incident angle of 5 degrees is 3% or less.

Satisfying the spectral characteristics (i-15) and (i-16) means that any main surface of the optical filter has a low reflectance of visible light.

The maximum reflectance R1_{450-600(5deg)MAX} is more preferably 2.5% or less, further preferably 2.0% or less, and still more preferably 1.5% or less.

The maximum reflectance R2_{450-600(5deg)MAX} is more preferably 2.5% or less, further preferably 2.0% or less, and still more preferably 1.5% or less.

The spectral characteristics (i-15) and (i-16) can be achieved, for example, by designing both the dielectric multilayer film 1 and the dielectric multilayer film 2 to have a low reflectance of visible light.

The optical filter according to the present embodiment preferably further satisfies the following spectral characteristic (i-17).

(i-17) An average transmittance T_{900-1000(0deg)AVE} at a wavelength of 900 nm to 1,000nm and an incident angle of 0 degrees is 10% or less.

Satisfying the spectral characteristic (i-17) means that the light-shielding properties in a near-infrared light region having a wavelength of 900 nm to 1,000 nm are excellent.

The average transmittance T_{900-1000(0deg)AVE} is more preferably 8.0% or less, further preferably 6.0% or less, still more preferably 5.0% or less, particularly preferably 3.5% or less, and most preferably 2.0% or less.

The spectral characteristic (i-17) can be achieved, for example, by using the phosphate glass to be described later as the near-infrared ray absorbing glass.

### <Dielectric Multilayer Film>

In the optical filter according to the present embodiment, the dielectric multilayer film 1 is laminated on a resin film side, and the dielectric multilayer film 2 is laminated on a near-infrared ray absorbing glass side.

It is preferable that at least the dielectric multilayer film 2 is designed as a layer having a low reflectance, that is, an antireflection layer, and more preferable that both the dielectric multilayer film 1 and the dielectric multilayer film 2 are designed as antireflection layers. As a result, an optical filter in which spectral characteristics are less likely to change with respect to light having a high incident angle is obtained. Ripple generation in the visible light region is also reduced. A wavelength region with low reflectance is preferably at least the visible light region of 450 nm to 600 nm and a near-infrared light region of 600 nm to 950 nm.

The antireflection layer is composed of, for example, a dielectric multilayer film in which dielectric films having different refractive indices are laminated. More specifically, examples of the dielectric films include a dielectric film having a low refractive index (low refractive index film), a dielectric film having a medium refractive index (medium refractive index film), and a dielectric film having a high refractive index (high refractive index film), and the antireflection layer is composed of a dielectric multilayer film in which two or more of those dielectric films are laminated.

A refractive index of the high refractive index film at a wavelength of 500 nm is preferably 1.6 or more, and more preferably 2.2 to 2.5. Examples of a material of the high refractive index film include Ta₂O₅, TiO₂, TiO, and Nb₂O₅. Other commercially available products thereof include OS50 (Ti₃O₅), OS10 (Ti₄O₇), OA500 (mixture of Ta₂O₅ and ZrO₂), and OA600 (mixture of Ta₂O₅ and TiO₂) manufactured by Canon Optron, Inc. Among those, TiO₂ is preferable from the viewpoint of reproducibility in film formability and refractive index, stability, and the like.

A refractive index of the medium refractive index film at a wavelength of 500 nm is preferably 1.6 or more and less than 2.2. Examples of a material of the medium refractive index film include ZrO₂, Nb₂O₅, Al₂O₃, HfO₂, OM-4, OM-6 (mixtures of Al₂O₃ and ZrO₂), and OA-100 sold by Canon Optron, Inc., and H4 and M2 (alumina lanthania) sold by Merck KGaA. Among those, Al₂O₃-based compounds and mixtures of Al₂O₃ and ZrO₂ are preferable from the viewpoint of reproducibility in film formability and refractive index, stability, and the like. A refractive index of the low refractive index film at a wavelength of 500 nm is

preferably less than 1.6, and more preferably 1.38 to 1.5. Examples of a material of the low refractive index film include SiO₂, SiOₓN_{y}, and MgF₂. Other commercially available products thereof include S4F and S5F (mixtures of SiO₂ and Al₂O₃) manufactured by Canon Optron, Inc. Among those, SiO₂ is preferable from the viewpoint of reproducibility in film formability, stability, economic efficiency, and the like.

In order to obtain a dielectric multilayer film in which reflection characteristics are controlled as described above, several types of dielectric films having different spectral characteristics may be combined when transmitting and selecting a desired wavelength band.

The dielectric multilayer film 1 is preferably designed such that, when the dielectric multilayer film 1 side is set as the incident direction, the maximum reflectance R1_{450-600(5deg)MAX} at a wavelength of 450 nm to 600 nm and an incident angle of 5 degrees is 3% or less as described above in terms of the spectral characteristic (i-15) of the optical filter. The dielectric multilayer film 1 is preferably designed such that, when the dielectric multilayer film 1 side is set as the incident direction, a maximum reflectance R1_{430-950(5deg)MAX} at a wavelength of 430 nm to 950 nm and an incident angle of 5 degrees is 2% or less in terms of the spectral characteristic of the optical filter.

The dielectric multilayer film 2 is preferably designed such that, when the dielectric multilayer film 2 side is set as the incident direction, the maximum reflectance R2_{450-600(5deg)MAX} at a wavelength of 450 nm to 600 nm and an incident angle of 5 degrees is 3% or less as described above in terms of the spectral characteristic (i-16) of the optical filter. The dielectric multilayer film 2 is preferably designed such that, when the dielectric multilayer film 2 side is set as the incident direction, a maximum reflectance R2_{425-1000(5deg)MAX} at a wavelength of 425 nm to 1,000 nm and an incident angle of 5 degrees is 4% or less, and a maximum reflectance R2_{430-700(5deg)MAX} at a wavelength of 430 nm to 700 nm and an incident angle of 5 degrees is 2% or less in terms of the spectral characteristic of the optical filter.

The total number of laminated layers of dielectric multilayer films in the antireflection layer is preferably 30 or less, more preferably 20 or less, further preferably 18 or less, still more preferably 16 or less, and particularly preferably 15 or less.

A thickness of the antireflection layer as a whole is preferably 1 μm or less, and more preferably 200 nm to 600 nm.

The antireflection layer formed of the dielectric multilayer film 1 and the antireflection layer formed of the dielectric multilayer film 2 each preferably satisfy the above number of laminated layers and thickness.

For formation of the dielectric multilayer film, for example, a vacuum film formation process such as a CVD method, a sputtering method, or a vacuum deposition method, a wet film formation process such as a spraying method or a dipping method, or the like can be used.

The antireflection layer may provide predetermined optical characteristics by one layer (one group of dielectric multilayer films) or may provide the predetermined optical characteristics by two layers. When two or more antireflection layers are provided, the respective antireflection layers may have the same configuration or different configurations.

When the optical filter is mounted on the imaging device, the dielectric multilayer film 2 laminated on a glass surface is generally disposed on a lens side, and the dielectric multilayer film 1 laminated on a resin film surface is generally disposed on a sensor side.

### <Near-Infrared Ray Absorbing Glass>

The near-infrared ray absorbing glass in the optical filter according to the present embodiment preferably satisfies the following spectral characteristic (ii-1).
(ii-1) In a wavelength of 500 nm to 700 nm, an absolute value of a difference between a wavelength λ₈₀ at which an internal transmittance is 80% and a wavelength λ₂₀ at which an internal transmittance is 20% is 130 nm or less.

As a result, an optical filter satisfying the spectral characteristic (i-5) can be obtained.

The absolute value of the difference between the wavelength λ₈₀ and the wavelength λ₂₀ is more preferably 120 nm or less, further preferably 110 nm or less, still more preferably 100 nm or less, and particularly preferably 90 nm or less.

The near-infrared ray absorbing glass preferably satisfies the following spectral characteristic (ii-2).
(ii-2) An average internal transmittance T_{(in)1200-1700AVE} at a wavelength of 1,200 nm to 1,700 nm is 70% or less.

As a result, an optical filter satisfying the spectral characteristic (i-8) can be obtained.

The average internal transmittance T_{(in)1200-1700AVE} is more preferably 60% or less, further preferably 50% or less, still more preferably 40% or less, particularly preferably 30% or less, and most preferably 20% or less.

The near-infrared ray absorbing glass preferably satisfies the following spectral characteristics (ii-3) to (ii-5). Here, an internal transmittance of the near-infrared ray absorbing glass at a wavelength of 380 nm is defined as T₍ᵢₙ₎₃₈₀, an internal transmittance thereof at a wavelength of 550 nm is defined as T₍ᵢₙ₎₅₅₀, and an internal transmittance thereof at a wavelength of 950 nm is defined as T₍ᵢₙ₎₉₅₀.

$$( ii - 3 ) {T}_{( in ) 380} / {T}_{( in ) 950} \geq 10.$$

$$( ii - 4 ) {T}_{( in ) 550} / {T}_{( in ) 950} \geq 10.$$

$$( ii - 5 ) {T}_{( in ) 380} / {T}_{( in ) 550} \leq 2 .$$

As a result, an optical filter satisfying the spectral characteristics (i-1) to (i-8) can be obtained.

T₍ᵢₙ₎₃₈₀/T₍ᵢₙ₎₉₅₀ is more preferably 30 or more, further preferably 50 or more, still more preferably 100 or more, particularly preferably 200 or more, and most preferably 1,000 or more.

T₍ᵢₙ₎₅₅₀/T₍ᵢₙ₎₉₅₀ is more preferably 30 or more, further preferably 50 or more, still more preferably 100 or more, particularly preferably 200 or more, and most preferably 1,000 or more.

T₍ᵢₙ₎₃₈₀/T₍ᵢₙ₎₅₅₀ is more preferably 2.0 or less, further preferably 1.8 or less, still more preferably 1.5 or less, particularly preferably 1.2 or less, and most preferably 1.0 or less.

A Vickers hardness of the near-infrared ray absorbing glass is preferably 420 kgf/mm² or less, more preferably 410 kgf/mm² or less, further preferably 390 kgf/mm² or less, and still more preferably 370 kgf/mm² or less. When the Vickers hardness is within the above range, the near-infrared ray absorbing glass satisfying the above spectral characteristic (ii-1), that is, having a steep change in transmittance between the visible light transmission region and the near-infrared light shielding region is easily obtained. A mechanism thereof can be explained as follows. A near-infrared ray steepness in the near-infrared ray absorbing glass increases as a symmetry of a structure composed of oxygen ions coordinated to copper ions in the glass increases. The smaller Vickers hardness, that is, the easier deformation of the glass structure by an external force, indicates that the degree of freedom of the glass structure with respect to a space is increased, which makes it easier for the oxygen ions coordinated to the copper ions to take a structure with a high symmetry, and thus a near-infrared ray steepness is increased.

The Vickers hardness of the glass can be measured using, for example, a load cell type multiple Vickers hardness scale FLC-50V manufactured by FUTURE-TECH CORP.

The near-infrared ray absorbing glass is not limited as long as it is glass capable of obtaining the above spectral characteristics, and examples thereof include an absorbing glass containing copper ions. By containing copper ions that absorb light having a wavelength in the vicinity of 900 nm, near-infrared light of 700 nm to 1,200 nm and light of 1,200 nm to 1,700 nm can be shielded. Among those, phosphate glass containing copper ions is preferable from the viewpoint of easily obtaining the above spectral characteristics. The “phosphate glass” also includes silicophosphate glass in which a part of a skeleton of the glass is formed of SiO₂.

For example, it is preferable that the phosphate glass contains the following components constituting the glass. Respective content ratios of the following glass constituent components are expressed in mass % in terms of oxides.

P₂O₅ is a main component forming the glass, and is a component for enhancing near-infrared ray shielding properties, a steepness of the change in transmittance from the visible light transmission region to the near-infrared light shielding region (hereinafter, also referred to as “near-infrared ray steepness”), and shielding properties of light of 1,200 nm to 1,700 nm. When a content of P₂O₅ is 40% or more, an effect thereof can be sufficiently obtained, and when the content of P₂O₅ is 85% or less, problems such as glass instability and reduction in weather resistance are less likely to occur. Therefore, the content of P₂O₅ is preferably 40% to 85%, more preferably 50% to 84%, further preferably 52% to 83%, still more preferably 54% to 82%, particularly preferably 56% to 81%, and most preferably 60% to 80%.

Al₂O₃ is a main component forming the glass, and is a component for enhancing strength of the glass, enhancing the weather resistance of the glass, and the like. When a content of Al₂O₃ is 0.5% or more, an effect thereof is sufficiently obtained, and when the content of Al₂O₃ is 20% or less, problems such as glass instability, and reduction in near-infrared ray shielding properties, near-infrared ray steepness, and shielding properties of light of 1,200 nm to 1,700 nm are less likely to occur. Therefore, the content of Al₂O₃ is preferably 0.5% to 20%, more preferably 0.6% to 18%, further preferably 0.7% to 17%, still more preferably 0.8% to 16%, and most preferably 0.9% to 15.5%.

R₂O (where R₂O is one or more components selected from Li₂O, Na₂O, K₂O, Rb₂O, and Cs₂O) is a component for lowering a melting temperature of the glass, lowering a liquid phase temperature of the glass, stabilizing the glass, and the like. When a total content of R₂O (ΣR₂O) is 0.5% or more, an effect thereof is sufficiently obtained, and when the total content of R₂O is 20% or less, problems such as glass instability, and reduction in near-infrared ray shielding properties, near-infrared ray steepness, and shielding properties of light of 1,200 nm to 1,700 nm are less likely to occur, which is preferable. Therefore, the total content of R₂O is preferably 0.5% to 20%, more preferably 1% to 20%, further preferably 2% to 20%, still more preferably 3% to 20%, and most preferably 4% to 20%.

Li₂O is a component for lowering the melting temperature of the glass, lowering the liquid phase temperature of the glass, stabilizing the glass, and the like. A content of Li₂O is preferably 0% to 15%. When the content of Li₂O is 15% or less, problems such as glass instability, and reduction in near-infrared ray shielding properties, near-infrared ray steepness, and shielding properties of light of 1,200 nm to 1,700 nm are less likely to occur, which is preferable. The content of Li₂O is more preferably 0% to 8%, further preferably 0% to 7%, still more preferably 0% to 6%, and most preferably 0% to 5%.

Na₂O is a component for lowering the melting temperature of the glass, lowering the liquid phase temperature of the glass, stabilizing the glass, and the like. A content of Na₂O is preferably 0% to 15%. When the content of Na₂O is 15% or less, problems such as glass instability, and reduction in near-infrared ray shielding properties, near-infrared ray steepness, and shielding properties of light of 1,200 nm to 1,700 nm are less likely to occur, which is preferable. The content of Na₂O is more preferably 0.5% to 14%, further preferably 1% to 13%, still more preferably 2% to 13%, and most preferably 3% to 13%.

K₂O is a component having effects such as lowering the melting temperature of the glass and lowering the liquid phase temperature of the glass. A content of K₂O is preferably 0% to 20%. When the content of K₂O is 20% or less, problems such as glass instability, and reduction in near-infrared ray shielding properties, near-infrared ray steepness, and shielding properties of light of 1,200 nm to 1,700 nm are less likely to occur, which is preferable. The content of K₂O is more preferably 0.5% to 14%, further preferably 1% to 13%, still more preferably 2% to 13%, and most preferably 3% to 13%.

Rb₂O is a component having effects such as lowering the melting temperature of the glass and lowering the liquid phase temperature of the glass. A content of Rb₂O is preferably 0% to 15%. When the content of Rb₂O is 15% or less, problems such as glass instability, and reduction in near-infrared ray shielding properties, near-infrared ray steepness, and shielding properties of light of 1,200 nm to 1,700 nm are less likely to occur, which is preferable. The content of Rb₂O is more preferably 0.5% to 14%, further preferably 1% to 13%, still more preferably 2% to 13%, and most preferably 3% to 13%.

Cs₂O is a component having effects such as lowering the melting temperature of the glass and lowering the liquid phase temperature of the glass. A content of Cs₂O is preferably 0% to 15%. When the content of Cs₂O is 15% or less, problems such as glass instability, and reduction in near-infrared ray shielding properties, near-infrared ray steepness, and shielding properties of light of 1,200 nm to 1,700 nm are less likely to occur, which is preferable. The content of Cs₂O is more preferably 0.5% to 14%, further preferably 1% to 13%, still more preferably 2% to 13%, and most preferably 3% to 13%.

When two or more of the above alkali metal components represented by R₂O are simultaneously added, a mixed alkali effect is generated in the glass, and the mobility of R⁺ ions is reduced. Accordingly, when the glass comes into contact with water, a hydration reaction caused by ion exchange between H⁺ ions in water molecules and the R⁺ ions in the glass is inhibited, and the weather resistance of the glass is improved. Therefore, the glass of the present embodiment preferably contains two or more components selected from Li₂O, Na₂O, K₂O, Rb₂O, and Cs₂O. In this case, the total content (ΣR₂O) of R₂O (where R₂O is one or more components selected from Li₂O, Na₂O, K₂O, Rb₂O, and Cs₂O) is preferably 7% to 18% (where 7% is excluded). When the total content of R₂O is more than 7%, the effect thereof is sufficiently obtained, and when the total content of R₂O is 18% or less, problems such as glass instability, reduction in strength of the glass, and reduction in near-infrared ray shielding properties, near-infrared ray steepness, and shielding properties of light of 1,200 nm to 1,700 nm are less likely to occur, which is preferable. Therefore, ΣR₂O is preferably more than 7% and 18% or less, more preferably 7.5% to 17%, further preferably 8% to 16%, still more preferably 8.5% to 15%, and most preferably 9% to 14%.

R′O (where R′O is one or more components selected from CaO, MgO, BaO, SrO, and ZnO) is a component for lowering the melting temperature of the glass, lowering the liquid phase temperature of the glass, stabilizing the glass, enhancing the strength of the glass, and the like. A total content of R′O (ΣR′O) is preferably 0% to 40%. When the total content of R′O is 40% or less, problems such as glass instability, reduction in strength of the glass, and reduction in near-infrared ray shielding properties, near-infrared ray steepness, and shielding properties of light of 1,200 nm to 1,700 nm are less likely to occur, which is preferable. The total content of R′O is more preferably 0% to 30%, further preferably 0% to 20%, still more preferably 0% to 15%, particularly preferably 0% to 10%, and most preferably 0% to 5%.

CaO is a component for lowering the melting temperature of the glass, lowering the liquid phase temperature of the glass, stabilizing the glass, enhancing the strength of the glass, and the like. A content of CaO is preferably 0% to 10%. When the content of CaO is 10% or less, problems such as glass instability, and reduction in near-infrared ray shielding properties, near-infrared ray steepness, and shielding properties of light of 1,200 nm to 1,700 nm are less likely to occur, which is preferable. The content of CaO is more preferably 0% to 8%, further preferably 0% to 6%, still more preferably 0% to 5%, and most preferably 0% to 4%.

MgO is a component for lowering the melting temperature of the glass, lowering the liquid phase temperature of the glass, stabilizing the glass, enhancing the strength of the glass, and the like. A content of MgO is preferably 0% to 15%. When the content of MgO is 15% or less, problems such as glass instability, and reduction in near-infrared ray shielding properties, near-infrared ray steepness, and shielding properties of light of 1,200 nm to 1,700 nm are less likely to occur, which is preferable. The content of MgO is more preferably 0% to 13%, further preferably 0% to 10%, still more preferably 0% to 9%, and most preferably 0% to 8%.

BaO is a component for lowering the melting temperature of the glass, lowering the liquid phase temperature of the glass, stabilizing the glass, and the like. A content of BaO is preferably 0% to 40%. When the content of BaO is 40% or less, problems such as glass instability, and reduction in near-infrared ray shielding properties, near-infrared ray steepness, and shielding properties of light of 1,200 nm to 1,700 nm are less likely to occur, which is preferable. The content of BaO is more preferably 0% to 30%, further preferably 0% to 20%, still more preferably 0% to 10%, and most preferably 0% to 5%.

SrO is a component for lowering the melting temperature of the glass, lowering the liquid phase temperature of the glass, stabilizing the glass, and the like. A content of SrO is preferably 0% to 10%. When the content of SrO is 10% or less, problems such as glass instability, and reduction in near-infrared ray shielding properties, near-infrared ray steepness, and shielding properties of light of 1,200 nm to 1,700 nm are less likely to occur, which is preferable. The content of SrO is more preferably 0% to 8%, further preferably 0% to 7%, and most preferably 0% to 6%.

ZnO has effects such as lowering the melting temperature of the glass and lowering the liquid phase temperature of the glass. A content of ZnO is preferably 0% to 15%. When the content of ZnO is 15% or less, problems such as glass instability, deterioration in solubility of the glass, and reduction in near-infrared ray shielding properties, near-infrared ray steepness, and shielding properties of light of 1,200 nm to 1,700 nm are less likely to occur, which is preferable. The content of ZnO is more preferably 0% to 13%, further preferably 0% to 10%, still more preferably 0% to 9%, and most preferably 0% to 8%.

CuO is a component for enhancing the near-infrared ray shielding properties and the shielding properties of light of 1,200 nm to 1,700 nm. When a content of CuO is 0.5% or more, an effect thereof can be sufficiently obtained, and when the content of CuO is 40% or less, problems such as generation of devitrification foreign matters in the glass and reduction in transmittance of light in a visible region are less likely to occur, which is preferable. The content of CuO is more preferably 1.0% to 30%, further preferably 2.0% to 25%, still more preferably 4.0% to 20%, and most preferably 5.0% to 15%.

In the phosphate glass in the optical filter according to the present embodiment, F may be contained in a range of 10% or less in order to enhance the weather resistance. When a content of F is 10% or less, problems such as reduction in near-infrared ray cutting property and generation of devitrification foreign matters in the glass are less likely to occur, which is preferable. The content of F is more preferably 9% or less, further preferably 8% or less, still more preferably 7% or less, particularly preferably 6% or less, and most preferably 5% or less.

B₂O₃ may be contained in a range of 10% or less for stabilizing the glass. When a content of B₂O₃ is 10% or less, problems such as deterioration in weather resistance of the glass, and reduction in near-infrared ray shielding properties, near-infrared ray steepness, and shielding properties of light of 1,200 nm to 1,700 nm are less likely to occur, which is preferable. The content of B₂O₃ is more preferably 9% or less, further preferably 8% or less, still more preferably 7% or less, particularly preferably 6% or less, and most preferably 5% or less.

In the phosphate glass in the optical filter according to the present embodiment, SiO₂, GeO₂, ZrO₂, SnO₂, TiO₂, CeO₂, WO₃, Y₂O₃, La₂O₃, Gd₂O₃, Yb₂O₃, Nb₂O₅, and MoO₃ may be contained in a range of 5% or less in order to improve the weather resistance of the glass. When a content of these components is 5% or less, problems such as generation of devitrification foreign matters in the glass, and reduction in near-infrared ray shielding properties, near-infrared ray steepness, and shielding properties of light of 1,200 nm to 1,700 nm are less likely to occur, which is preferable. The content of these components is more preferably 4% or less, further preferably 3% or less, still more preferably 2% or less, and most preferably 1% or less.

Any of Fe₂O₃, Cr₂O₃, Bi₂O₃, NiO, V₂O₅, MnO₂, and CoO is a component that reduces the transmittance of light in the visible region by being present in the glass. Therefore, it is preferable that these components are not substantially contained in the glass.

In the present invention, the expression “a specific component is not substantially contained” means that the component is not intentionally added, and does not exclude inclusion of the component to the extent that the component is unavoidably mixed in from raw materials, or the like, and does not affect desired properties.

A thickness of the phosphate glass is preferably 0.5 mm or less and more preferably 0.4 mm or less from the viewpoint of a reduction in height of camera modules, and is preferably 0.10 mm or more and more preferably 0.15 mm or more from the viewpoint of maintenance of device strength.

The phosphate glass can be prepared as follows, for example.

First, raw materials are weighed and mixed so as to fall within the above composition range (mixing step). The raw material mixture is accommodated in a platinum crucible, and heated and melted at a temperature of 700° C. to 1,400° C. in an electric furnace (melting step). After being sufficiently stirred and refined, the raw material mixture is cast into a mold, cut and polished to form a flat plate having a predetermined thickness (molding step).

In the melting step of the above manufacturing method, the highest temperature of the glass during glass melting is preferably 1,400° C. or lower. When the highest temperature of the glass during glass melting is higher than the above temperature, transmittance characteristics may deteriorate. The above temperature is more preferably 1,350° C. or lower, further preferably 1,300° C. or lower, and still more preferably 1,250° C. or lower.

When the temperature in the above melting step is too low, problems such as occurrence of devitrification during melting and requirement of a long time for burn through may occur, and thus the temperature is preferably 700° C. or higher, and more preferably 800° C. or higher.

### <Resin Film>

The resin film in the optical filter according to the present embodiment includes a resin and a near-infrared ray absorbing dye having a maximum absorption wavelength in 690 nm to 800 nm in the resin. Here, the resin refers to a resin constituting the resin film.

Since the resin film of the present invention contains a dye having a maximum absorption wavelength in 690 nm to 800 nm, a near-infrared light region in the vicinity of 700nm where the light-shielding properties of the near-infrared ray absorbing glass are slightly weak can be shielded by absorption characteristics of the dye.

Examples of the near-infrared ray absorbing dye include at least one selected from the group consisting of a cyanine dye, a phthalocyanine dye, a squarylium dye, a naphthalocyanine dye, and a diimonium dye, and one thereof or a plurality thereof as a mixture can be used. Among those, the squarylium dye and the cyanine dye are preferable from the viewpoint of easily exhibiting the effect of the present invention.

A content of the near-infrared ray absorbing dye in the resin film is preferably 0.1 parts by mass to 30 parts by mass, and more preferably 0.1 parts by mass to 20 parts by mass with respect to 100 parts by mass of the resin. When two or more compounds are combined, the above content is a sum of respective compounds.

The resin film may contain other dyes, for example, an ultraviolet light-absorbing dye, as long as the effect of the present invention is not impaired.

Examples of the ultraviolet light-absorbing dye include an oxazole dye, a merocyanine dye, a cyanine dye, a naphthalimide dye, an oxadiazole dye, an oxazine dye, an oxazolidine dye, a naphthalic acid dye, a styryl dye, an anthracene dye, a cyclic carbonyl dye, and a triazole dye. Among those, the merocyanine dye is particularly preferable. These dyes may be used alone, or may be used in combination of two or more kinds thereof.

The resin is not limited as long as it is a transparent resin, and one or more kinds of transparent resins selected from a polyester resin, an acrylic resin, an epoxy resin, an ene-thiol resin, a polycarbonate resin, a polyether resin, a polyarylate resin, a polysulfone resin, a polyethersulfone resin, a poly (p-phenylene) resin, a polyarylene ether phosphine oxide resin, a polyamide resin, a polyimide resin, a polyamide-imide resin, a polyolefin resin, a cyclic olefin resin, a polyurethane resin, a polystyrene resin, and the like are used. These resins may be used alone, or may be used by mixing two or more kinds thereof.

One or more kinds of resins selected from the polyimide resin, the polycarbonate resin, the polyester resin, and the acrylic resin are preferable from the viewpoint of spectral characteristics, a glass transition temperature (Tg), and adhesion of the resin film.

When a plurality of dyes are used, these dyes may be contained in the same resin film or may be contained in different resin films.

The resin film can be formed by dissolving or dispersing a dye, a resin or a raw material component of the resin, and respective components blended as necessary in a solvent to prepare a coating solution, applying the coating solution to a support, drying the coating solution, and further curing the coating solution as necessary. The support in this case may be the phosphate glass used for the present filter, or may be a peelable support used only when the resin film is to be formed. The solvent may be a dispersion medium capable of stably dispersing components or a solvent capable of dissolving components.

The coating solution may contain a surfactant in order to improve voids due to fine bubbles, depressions due to adhesion of foreign matters and the like, and repelling in a drying step. Further, for the application of the coating solution, for example, a dip coating method, a cast coating method, or a spin coating method can be used. The above coating solution is applied onto the support and then dried to form a resin film. When the coating solution contains a raw material component of the transparent resin, a curing process such as thermal curing or photocuring is further performed.

The resin film can also be manufactured into a film shape by extrusion molding. A substrate can be manufactured by laminating the obtained film-shaped resin film on the phosphate glass and integrating the resin film and the phosphate glass by thermal press fitting or the like.

The optical filter may have one layer of the resin film, or may have two or more layers of the resin film. When the optical filter has two or more layers of the resin film, respective layers may have the same configuration or different configurations.

A thickness of the resin film is 10 μm or less and preferably 5 μm or less from the viewpoint of in-plane thickness distribution and appearance quality in a substrate after coating, and is preferably 0.5 μm or more from the viewpoint of exhibiting desired spectral characteristics at an appropriate dye concentration. When the optical filter has two or more layers of the resin film, a total thickness of the respective resin films is preferably within the above range.

The optical filter of the present embodiment may include, as another component, for example, a component (layer) that provides absorption by inorganic fine particles or the like that control transmission and absorption of light in a specific wavelength region. Specific examples of the inorganic fine particles include indium tin oxides (ITO), antimony-doped tin oxides (ATO), cesium tungstate, and lanthanum boride. The ITO fine particles and the cesium tungstate fine particles have a high visible light transmittance and have light absorbing properties in a wide range of an infrared wavelength region exceeding 1,200 nm, and thus can be used in the case where shielding properties of infrared light are required.

For example, when the optical filter of the present embodiment is used in an imaging device such as a digital still camera, an imaging device having excellent color reproducibility can be provided. Such an imaging device includes a solid state image sensor, an imaging lens, and the optical filter of the present embodiment. The optical filter of the present embodiment can be used, for example, by being disposed between the imaging lens and the solid state image sensor, or by being directly attached to the solid state image sensor, the imaging lens, or the like of the imaging device via an adhesive layer.

As described above, the present description discloses the following optical filter and the like.

[1] The optical filter satisfies all of the following spectral characteristics (i-1) to (i-8).
(i-1) An average transmittance T_{450-600(0deg)AVE} at a wavelength of 450 nm to 600 nm and an incident angle of 0 degrees is 90% or more.
(i-2) An average transmittance T_{550-650(0deg)AVE} at a wavelength of 550 nm to 650 nm and an incident angle of 0 degrees is 70% or more.
(i-3) An average transmittance T_{550-650(60deg)AVE} at a wavelength of 550 nm to 650 nm and an incident angle of 60 degrees is 50% or more.
(i-4) An average transmittance T_{700-750(0deg)AVE} at a wavelength of 700 nm to 750 nm and an incident angle of 0 degrees is 5% or less.
(i-5) In a wavelength of 500 nm to 700 nm, an absolute value of a difference between a wavelength IR_{80(0deg)} at which a transmittance is 80% at an incident angle of 0 degrees and a wavelength IR_{20(0deg)} at which a transmittance is 20% at an incident angle of 0 degrees is 90 nm or less.
(i-6) In a wavelength of 500 nm to 700 nm, a wavelength IR_{50(0deg)} at which a transmittance is 50% at an incident angle of 0 degrees and a wavelength IR_{50(60deg)} at which a transmittance is 50% at an incident angle of 60 degrees are both in a wavelength region of 600 nm to 660 nm, and an absolute value of a difference between the wavelength IR_{50(0deg)} and the wavelength IR_{50(60deg)} is 30 nm or less.
(i-7) An average transmittance T_{800-1200(0deg)AVE} at a wavelength of 800 nm to 1,200 nm and an incident angle of 0 degrees is 15% or less.
(i-8) An average transmittance T_{1200-1700(0deg)AVE} at a wavelength of 1,200 nm to 1,700 nm and an incident angle of 0 degrees is 50% or less.

[2] The optical filter according to [1], in which
the optical filter includes a dielectric multilayer film 1, a resin film, a near-infrared ray absorbing glass, and a dielectric multilayer film 2 in this order,
the resin film includes a resin and a near-infrared ray absorbing dye having a maximum absorption wavelength in 690 nm to 800 nm in the resin, and the resin film has a thickness of 10 μm or less.

[3] The optical filter according to [2], in which
the near-infrared ray absorbing glass has a Vickers hardness of 420 kgf/mm² or less.

[4] The optical filter according to [2] or [3], in which
the near-infrared ray absorbing glass satisfies the following spectral characteristic (ii-1).
(ii-1) In a wavelength of 500 nm to 700 nm, an absolute value of a difference between a wavelength λ₈₀ at which an internal transmittance is 80% and a wavelength λ₂₀ at which an internal transmittance is 20% is 130 nm or less.

[5] The optical filter according to any of [2] to [4], in which
the near-infrared ray absorbing glass satisfies the following spectral characteristic (ii-2).
(ii-2) An average internal transmittance T_{(in)1200-1700AVE} at a wavelength of 1,200 nm to 1,700 nm is 70% or less.

[6] The optical filter according to any of [2] to [5], in which
when an internal transmittance of the near-infrared ray absorbing glass at a wavelength of 380 nm is defined as T₍ᵢₙ₎₃₈₀, an internal transmittance of the near-infrared ray absorbing glass at a wavelength of 550 nm is defined as T₍ᵢₙ₎₅₅₀, and an internal transmittance of the near-infrared ray absorbing glass at a wavelength of 950 nm is defined as T₍ᵢₙ₎₉₅₀, the following spectral characteristics (ii-3) to (ii-5) are all satisfied.

$$( ii - 3 ) {T}_{( in ) 380} / {T}_{( in ) 950} \geq 10.$$

$$( ii - 4 ) {T}_{( in ) 550} / {T}_{( in ) 950} \geq 10.$$

$$( ii - 5 ) {T}_{( in ) 380} / {T}_{( in ) 550} \leq 2 .$$

[7] The optical filter according to any of [1] to [6], further satisfying the following spectral characteristics (i-9) and (i-10).
(i-9) A maximum transmittance T_{750-1200(0deg)MAX} at a wavelength of 750 nm to 1,200 nm and an incident angle of 0 degrees is 30% or less.
(i-10) A maximum transmittance T_{750-1200(60deg)MAX} at a wavelength of 750 nm to 1,200 nm and an incident angle of 60 degrees is 30% or less.

[8] The optical filter according to any of [1] to [7], further satisfying the following spectral characteristics (i-11) to (i-14).
(i-11) An average transmittance T_{450-600(60deg)AVE} at a wavelength of 450 nm to 600 nm and an incident angle of 60 degrees is 80% or more.
(i-12) An absolute value of a difference between the average transmittance T_{450-600(0deg)AVE} and the average transmittance T_{450-600(60deg)AVE} is 10% or less.
(i-13) A maximum transmittance T_{1000-1200(0deg)MAX} at a wavelength of 1,000 nm to 1,200 nm and an incident angle of 0 degrees is 30% or less.
(i-14) A maximum transmittance T_{1000-1200(60deg)MAX} at a wavelength of 1,000 nm to 1,200 nm and an incident angle of 60 degrees is 20% or less.

[9] The optical filter according to any of [1] to [8], further satisfying the following spectral characteristics (i-15) and (i-16).
(i-15) When a dielectric multilayer film 1 side is set as an incident direction, a maximum reflectance R1_{450-600(5deg)MAX} at a wavelength of 450 nm to 600 nm and an incident angle of 5 degrees is 3% or less.
(i-16) When a dielectric multilayer film 2 side is set as an incident direction, a maximum reflectance R2_{450-600(5deg)MAX} at a wavelength of 450 nm to 600 nm and an incident angle of 5 degrees is 3% or less.

[10] The optical filter according to any of [1] to [9], further satisfying the following spectral characteristic (i-17).
(i-17) An average transmittance T_{900-1000(0deg)AVE} at a wavelength of 900 nm to 1,000 nm and an incident angle of 0 degrees is 10% or less.

[11] The optical filter according to any of [2] to [10], in which the near-infrared ray absorbing glass contains, in terms of mass % based on oxide,
40% to 85% of P₂O₅,
0.5% to 20% of Al₂O₃,
0.5% to 20% of ΣR₂O (where R₂O is one or more components selected from Li₂O, Na₂O, K₂O, Rb₂O, and Cs₂O, and ΣR₂O is a total content of R₂O),
0% to 40% of ΣR′O (where R′O is one or more components selected from CaO, MgO, BaO, SrO, and ZnO, and ΣR′O is a total content of R′O), and
0.5% to 40% of CuO.

[12] An imaging device including the optical filter according to any of [1] to [11].

### EXAMPLES

Next, the present invention is described more specifically with reference to examples.

For measurement of each spectral characteristic, an ultraviolet-visible spectrophotometer (UH-4150 type, manufactured by Hitachi High-Tech Corporation) was used.

The spectral characteristic in the case where an incident angle is not particularly specified is a value measured at an incident angle of 0 degrees (in a direction perpendicular to a main surface of the optical filter).

For measurement of the Vickers hardness of the glass, a load cell type multiple Vickers hardness scale FLC-50V manufactured by FUTURE-TECH CORP was used under a load of 100 gf.

Dyes used in respective examples are as follows.
Compound 1 (squarylium compound): synthesized based on WO2017/135359.
Compound 2 (cyanine compound): synthesized based on a method described in Dyes and pigments, 73, 344 to 352 (2007).
Compound 3 (merocyanine compound): synthesized based on the description of German Patent No. 10109243.

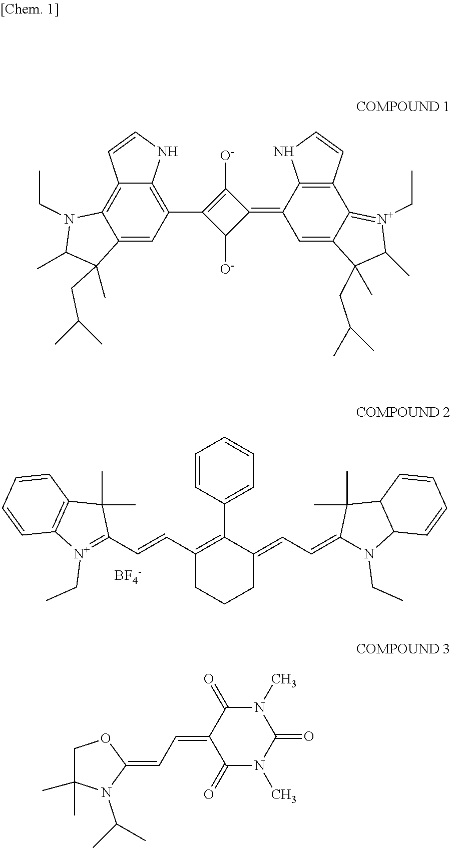

### <Spectral Characteristics of Dye in Resin>

A polyimide resin (“C3G30G” (trade name), manufactured by Mitsubishi Gas Chemical Company, Inc., refractive index: 1.59) was dissolved in a mixture of γ-butyrolactone (GBL):cyclohexanone=1:1 (mass ratio) to prepare a polyimide resin solution having a resin concentration of 8.5 mass %.

Each of the dyes of the above compounds 1 to 3 was added to the resin solution at a concentration of 7.5 parts by mass with respect to 100 parts by mass of the resin, and stirred and dissolved at 50° C. for 2 hours to obtain a coating solution. The obtained coating solution was applied to an alkaline glass (D263 glass, manufactured by SCHOTT, thickness: 0.2 mm) by a spin coating method to form a coating film having a thickness of about 1.0 μm.

With respect to the obtained coating film, a spectral transmittance curve in a wavelength range of 350 nm to 1,200 nm was measured using the ultraviolet-visible spectrophotometer.

The spectral characteristics in the polyimide resin of the above compounds 1 to 3 are shown in Table 1 below. The spectral characteristics shown in the following table were evaluated in terms of internal transmittance in order to avoid an influence of reflection at an air interface and a glass interface.

TABLE 1

| | Maximum absorption |
|---|---|
| Dye number | wavelength in resin |
| Compound 1 | 752 nm |
| Compound 2 | 773 nm |
| Compound 3 | 400 nm |

### <Spectral Characteristics of Near-infrared Ray Absorbing Glass>

As the near-infrared ray absorbing glass, a fluorophosphate glass 1 and phosphate glasses 1 to 4 having compositions shown in the following table were prepared.

Raw materials were weighed and mixed so as to have the compositions (mass % based on oxide) shown in the following table, and the mixture was put into a crucible having an internal volume of about 400 cc and melted in an air atmosphere for 2 hours. Thereafter, the mixture was refined, stirred, and cast into a rectangular mold having a length of 100 mm, a width of 80 mm, and a height of 20 mm that was preheated to about 300° C. to 500° C., and then slowly cooled at about 1° C./min to obtain a plate-like glass having a length of 40 mm, a width of 30 mm, and a thickness (mm) shown in Table 3 to be described later, both surfaces of which were optically polished.

The Vickers hardness and specific gravity of each glass are shown in Table 2 below.

TABLE 2

| | | Phos- | Phos- | Phos- | Phos- |
|---|---|---|---|---|---|
| | Fluorophosphate | phate | phate | phate | phate |
| mass % | glass | glass 1 | glass 2 | glass 3 | glass 4 |
| P₂O₅ | 41.45 | 68.73 | 71.47 | 79.04 | 71.31 |
| Al₂O₃ | 6.27 | 11.36 | 8.33 | 1.29 | 8.29 |
| Li₂O | 4.87 | 0.00 | 1.23 | 1.20 | 0.00 |
| Na₂O | 0.00 | 3.16 | 2.55 | 2.48 | 2.22 |
| K₂O | 0.00 | 9.06 | 3.87 | 3.77 | 10.21 |
| CaO | 3.37 | 0.00 | 0.00 | 0.00 | 0.00 |
| SrO | 7.75 | 0.00 | 0.00 | 0.00 | 0.00 |
| BaO | 11.91 | 0.00 | 4.57 | 4.45 | 0.00 |
| CuO | 3.08 | 7.68 | 7.98 | 7.77 | 7.97 |
| F | 21.28 | 0.00 | 0.00 | 0.00 | 0.00 |
| Total | 100 | 100 | 100 | 100 | 100 |
| Vickers | 423 | 410 | 401 | 354 | 363 |
| hardness Hv | | | | | |
| (kgf/mm²) | | | | | |
| Specific gravity | 3.12 | 2.72 | 2.76 | 2.67 | 2.65 |

With respect to the respective near-infrared ray absorbing glass, a spectral transmittance curve in a wavelength range of 300 nm to 1,700 nm was measured using the ultraviolet-visible spectrophotometer.

The obtained spectral characteristics are shown in Table 3 below. The spectral characteristics shown in the following table were evaluated in terms of internal transmittance in order to avoid an influence of reflection at an air interface and a glass interface.

Spectral transmittance curves of the respective near-infrared ray absorbing glass are illustrated in FIG. 2.

TABLE 3

| | | Fluorophosphate | Phosphate | Phosphate | Phosphate | Phosphate |
|---|---|---|---|---|---|---|
| | Type | glass | glass 1 | glass 2 | glass 3 | glass 4 |
| Glass | Thickness (mm) | 0.200 | 0.187 | 0.207 | 0.356 | 0.318 |
| Spectral | Wavelength λ80 at which | 608 | 609 | 611 | 617 | 612 |
| characteristics | internal transmittance is 80% | | | | | |
| | (nm) | | | | | |
| | Wavelength λ20 at which | 739 | 724 | 719 | 703 | 710 |
| | internal transmittance is 20% | | | | | |
| | (nm) | | | | | |
| | \|Wavelength λ80-wavelength | 131 | 115 | 108 | 86 | 98 |
| | λ20\| (nm) | | | | | |
| | internal transmittance (%) | 71.68 | 43.04 | 40.09 | 19.82 | 26.78 |
| | 1,200-1,700 nm average | | | | | |
| | 380 nm internal transmittance | 95.38 | 93.56 | 92.89 | 88.72 | 89.88 |
| | T(in)380 (%) | | | | | |
| | 550 nm internal transmittance | 96.75 | 96.66 | 97.19 | 97.26 | 96.27 |
| | T(in)550 (%) | | | | | |
| | 950 nm internal transmittance | 16.11 | 3.02 | 2.03 | 0.07 | 0.37 |
| | T(in)950 (%) | | | | | |
| | T(in)380/T(in)950 | 5.92 | 30.97 | 45.78 | 1,315.19 | 241.26 |
| | T(in)550/T(in)950 | 6.00 | 32.00 | 47.90 | 1,441.66 | 258.43 |
| | T(in)380/T(in)550 | 0.99 | 0.97 | 0.96 | 0.91 | 0.93 |

As described above, it is understood that the phosphate glass 1 to 4 have a high transmittance in the visible light region, are excellent in light-shielding properties in a near-infrared region, and are particularly excellent in light-shielding properties in a near-infrared region of 1,200 nm or more. It can be understood that in the fluorophosphate glass, an average transmittance thereof particularly increases at 1,200 nm or more, and light-shielding properties thereof in the near-infrared region is lower than those of the phosphate glass 1 to 4.

### <Example 1-1: Spectral Characteristics of Resin Film>

The dyes of the compounds 1 to 3 were mixed with a polyimide resin solution prepared in the same manner as in calculation of the spectral characteristics of the above compounds at a concentration shown in the following table, and stirred and dissolved at 50° C. for 2 hours to obtain a coating solution. The obtained coating solution was applied to an alkaline glass (D263 glass, manufactured by SCHOTT, thickness: 0.2 mm) by a spin coating method to form a resin film having a thickness of 3.0 μm.

With respect to the obtained resin film, a spectral transmittance curve in a wavelength range of 350 nm to 1,200 nm was measured using the ultraviolet-visible spectrophotometer.

The obtained results of the spectral characteristics are shown in Table 4 below. The spectral characteristics shown in the following table were evaluated in terms of internal transmittance in order to avoid an influence of reflection at an air interface and a glass interface.

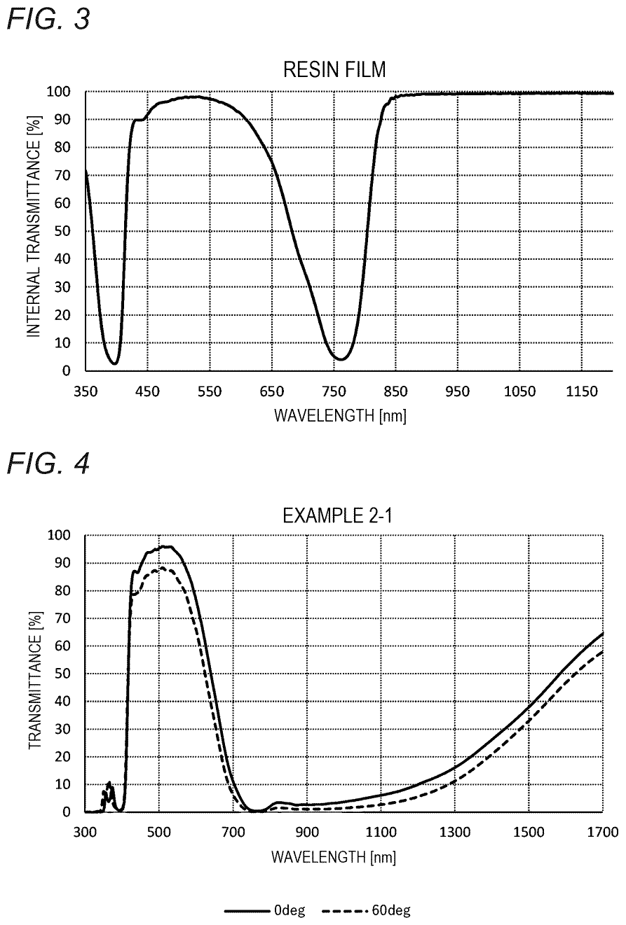

A spectral transmittance curve of the resin film of Example 1-1 is illustrated in FIG. 3.

Example 1-1 is a reference example.

TABLE 4

| | | Example |
|---|---|---|
| | | 1-1 |
| Added amount | Compound 1 (λMAX: 752 nm) | 2.33 |
| of dye | Compound 2 (λMAX: 773 nm) | 2.60 |
| (mass %) | Compound 3 (λMAX: 400 nm) | 6.19 |
| | Total | 11.11 |
| Spectral | 450 nm internal transmittance (%) | 91.6 |
| characteristics | 450-600 nm average internal transmittance | 96.2 |
| of resin film | (%) | |
| | IR50 (nm) | 683 |

### <Example 2-1: Spectral Characteristics of Optical Filter>

A resin film was formed on one main surface of the phosphate glass 1 as the near-infrared ray absorbing glass in the same manner as in Example 1-1. TiO₂ and SiO₂ were laminated on a surface of the resin film in an order and a thickness (nm) shown in the following table by vapor deposition to form a dielectric multilayer film 1. TiO₂ and SiO₂ were laminated on the other main surface of the phosphate glass 1 in an order and a thickness (nm) shown in the following table by vapor deposition to form a dielectric multilayer film 2.

In this manner, an optical filter having a configuration of dielectric multilayer film 2 (front surface)/near-infrared ray absorbing glass/resin film/dielectric multilayer film 1 (rear surface) was prepared.

### <Examples 2-2 to 2-6: Spectral Characteristics of Optical Filter>

Optical filters were prepared in the same manner as in Example 2-1 except that the near-infrared ray absorbing glass, the dielectric multilayer film 1, and the dielectric multilayer film 2 were changed to have configurations shown in Table 5 below.

The dielectric multilayer film 2 of Examples 2-6 is a reflection layer having reflection characteristics in the near-infrared light region, the dielectric multilayer films 1 and the dielectric multilayer films 2 of Examples 2-1 to 2-5, and the dielectric multilayer film 1 of Example 2-6 are antireflection layers.

TABLE 5

| Optical filter | | Example 2-1 | | Example 2-2 | | Example 2-3 | | Example 2-4 | | Example 2-5 | | Example 2-6 | |
|---|---|---|---|---|---|---|---|---|---|---|---|---|---|
| Dielectric | 12 | SiO₂ | 101.43 | SiO₂ | 101.43 | SiO₂ | 101.43 | SiO₂ | 101.43 | SiO₂ | 101.43 | SiO₂ | 101.43 |
| multilayer | 11 | TiO₂ | 33.35 | TiO₂ | 33.35 | TiO₂ | 33.35 | TiO₂ | 33.35 | TiO₂ | 33.35 | TiO₂ | 33.35 |
| film 1 | 10 | SiO₂ | 13.18 | SiO₂ | 13.18 | SiO₂ | 13.18 | SiO₂ | 13.18 | SiO₂ | 13.18 | SiO₂ | 13.18 |
| | 9 | TiO₂ | 88.64 | TiO₂ | 88.64 | TiO₂ | 88.64 | TiO₂ | 88.64 | TiO₂ | 88.64 | TiO₂ | 88.64 |
| | 8 | SiO₂ | 6.83 | SiO₂ | 6.83 | SiO₂ | 6.83 | SiO₂ | 6.83 | SiO₂ | 6.83 | SiO₂ | 6.83 |
| | 7 | TiO₂ | 57.93 | TiO₂ | 57.93 | TiO₂ | 57.93 | TiO₂ | 57.93 | TiO₂ | 57.93 | TiO₂ | 57.93 |
| | 6 | SiO₂ | 9.18 | SiO₂ | 9.18 | SiO₂ | 9.18 | SiO₂ | 9.18 | SiO₂ | 9.18 | SiO₂ | 9.18 |
| | 5 | TiO₂ | 157.91 | TiO₂ | 157.91 | TiO₂ | 157.91 | TiO₂ | 157.91 | TiO₂ | 157.91 | TiO₂ | 157.91 |
| | 4 | SiO₂ | 22.43 | SiO₂ | 22.43 | SiO₂ | 22.43 | SiO₂ | 22.43 | SiO₂ | 22.43 | SiO₂ | 22.43 |
| | 3 | TiO₂ | 28.14 | TiO₂ | 28.14 | TiO₂ | 28.14 | TiO₂ | 28.14 | TiO₂ | 28.14 | TiO₂ | 28.14 |
| | 2 | SiO₂ | 48.08 | SiO₂ | 48.08 | SiO₂ | 48.08 | SiO₂ | 48.08 | SiO₂ | 48.08 | SiO₂ | 48.08 |
| | 1 | TiO₂ | 9.2 | TiO₂ | 9.2 | TiO₂ | 9.2 | TiO₂ | 9.2 | TiO₂ | 9.2 | TiO₂ | 9.2 |

| | | Resin film | | | | | | | | | | | |
|---|---|---|---|---|---|---|---|---|---|---|---|---|---|
| | | Resin film 1-1 | | Resin film 1-1 | | Resin film 1-1 | | Resin film 1-1 | | Resin film 1-1 | | Resin film 1-1 | |
| | | Glass | | | | | | | | | | | |
| | | Phosphate | | Phosphate | | Phosphate | | Phosphate | | Fluorophosphate | | Fluorophosphate | |
| | | glass 1 | | glass 2 | | glass 3 | | glass 4 | | glass | | glass | |
| Dielectric | 1 | TiO₂ | 9.79 | TiO₂ | 9.79 | TiO₂ | 9.79 | TiO₂ | 9.79 | TiO₂ | 9.79 | TiO₂ | 13.45 |
| multilayer | 2 | SiO₂ | 53.72 | SiO₂ | 53.72 | SiO₂ | 53.72 | SiO₂ | 53.72 | SiO₂ | 53.72 | SiO₂ | 37.02 |
| film 2 | 3 | TiO₂ | 28.6 | TiO₂ | 28.6 | TiO₂ | 28.6 | TiO₂ | 28.6 | TiO₂ | 28.6 | TiO₂ | 115.97 |
| | 4 | SiO₂ | 23.95 | SiO₂ | 23.95 | SiO₂ | 23.95 | SiO₂ | 23.95 | SiO₂ | 23.95 | SiO₂ | 181.66 |
| | 5 | TiO₂ | 157.07 | TiO₂ | 157.07 | TiO₂ | 157.07 | TiO₂ | 157.07 | TiO₂ | 157.07 | TiO₂ | 108.92 |
| | 6 | SiO₂ | 12.43 | SiO₂ | 12.43 | SiO₂ | 12.43 | SiO₂ | 12.43 | SiO₂ | 12.43 | SiO₂ | 184.56 |
| | 7 | TiO₂ | 52.41 | TiO₂ | 52.41 | TiO₂ | 52.41 | TiO₂ | 52.41 | TiO₂ | 52.41 | TiO₂ | 110.81 |
| | 8 | SiO₂ | 9.95 | SiO₂ | 9.95 | SiO₂ | 9.95 | SiO₂ | 9.95 | SiO₂ | 9.95 | SiO₂ | 186.26 |
| | 9 | TiO₂ | 87.25 | TiO₂ | 87.25 | TiO₂ | 87.25 | TiO₂ | 87.25 | TiO₂ | 87.25 | TiO₂ | 108.56 |
| | 10 | SiO₂ | 16.04 | SiO₂ | 16.04 | SiO₂ | 16.04 | SiO₂ | 16.04 | SiO₂ | 16.04 | SiO₂ | 184.11 |
| | 11 | TiO₂ | 31.11 | TiO₂ | 31.11 | TiO₂ | 31.11 | TiO₂ | 31.11 | TiO₂ | 31.11 | TiO₂ | 110.1 |
| | 12 | SiO₂ | 107.26 | SiO₂ | 107.26 | SiO₂ | 107.26 | SiO₂ | 107.26 | SiO₂ | 107.26 | SiO₂ | 180.99 |
| | 13 | | | | | | | | | | | TiO₂ | 106.56 |
| | 14 | | | | | | | | | | | SiO₂ | 180.34 |
| | 15 | | | | | | | | | | | TiO₂ | 106.55 |
| | 16 | | | | | | | | | | | SiO₂ | 172.01 |
| | 17 | | | | | | | | | | | TiO₂ | 95.45 |
| | 18 | | | | | | | | | | | SiO₂ | 157.6 |
| | 19 | | | | | | | | | | | TiO₂ | 89.83 |
| | 20 | | | | | | | | | | | SiO₂ | 155.01 |
| | 21 | | | | | | | | | | | TiO₂ | 90.55 |
| | 22 | | | | | | | | | | | SiO₂ | 168.02 |
| | 23 | | | | | | | | | | | TiO₂ | 102.33 |
| | 24 | | | | | | | | | | | SiO₂ | 175.6 |
| | 25 | | | | | | | | | | | TiO₂ | 97.56 |
| | 26 | | | | | | | | | | | SiO₂ | 156 |
| | 27 | | | | | | | | | | | TiO₂ | 88.01 |
| | 28 | | | | | | | | | | | SiO₂ | 149.34 |
| | 29 | | | | | | | | | | | TiO₂ | 84.39 |
| | 30 | | | | | | | | | | | SiO₂ | 145.07 |
| | 31 | | | | | | | | | | | TiO₂ | 83.75 |
| | 32 | | | | | | | | | | | SiO₂ | 145.87 |
| | 33 | | | | | | | | | | | TiO₂ | 85.29 |
| | 34 | | | | | | | | | | | SiO₂ | 143.21 |
| | 35 | | | | | | | | | | | TiO₂ | 83.7 |
| | 36 | | | | | | | | | | | SiO₂ | 147.86 |
| | 37 | | | | | | | | | | | TiO₂ | 87.06 |
| | 38 | | | | | | | | | | | SiO₂ | 150.17 |
| | 39 | | | | | | | | | | | TiO₂ | 82.53 |
| | 40 | | | | | | | | | | | SiO₂ | 70.51 |

With respect to each of the optical filters, spectral transmittance curves at an incident angle of 0 degrees and an incident angle of 60 degrees and a spectral reflectance curve at an incident angle of 5 degrees in a wavelength range of 300 nm to 1,700 nm were measured using the ultraviolet-visible spectrophotometer.

Results are shown in Table 6 below.

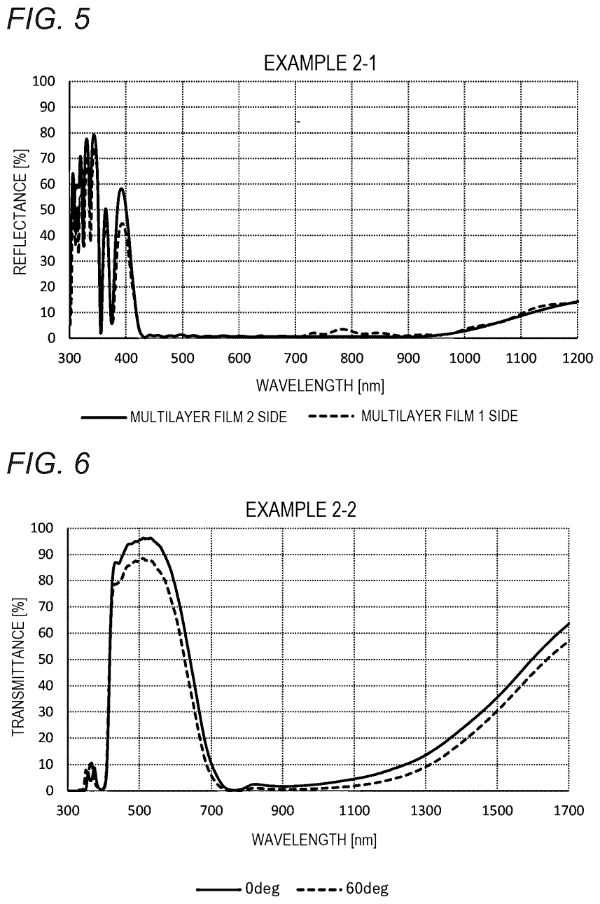

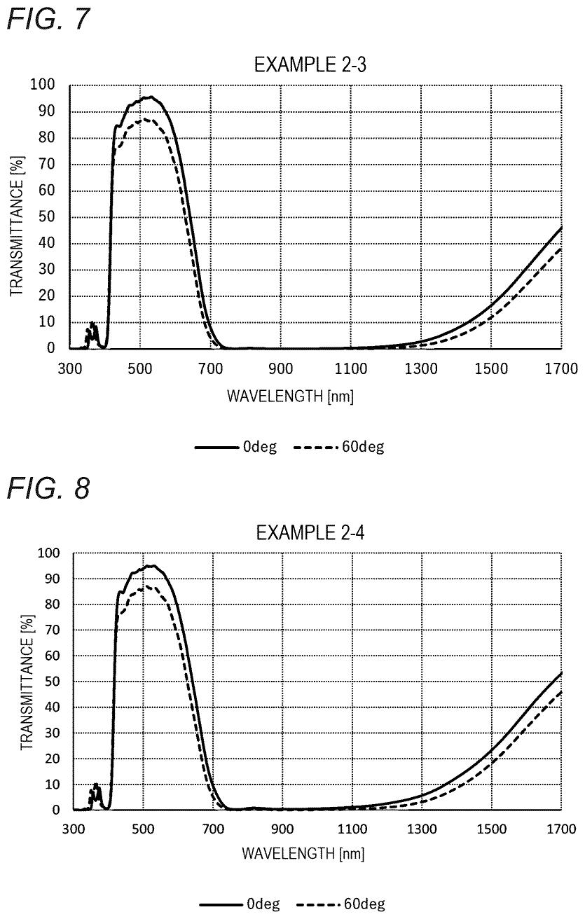

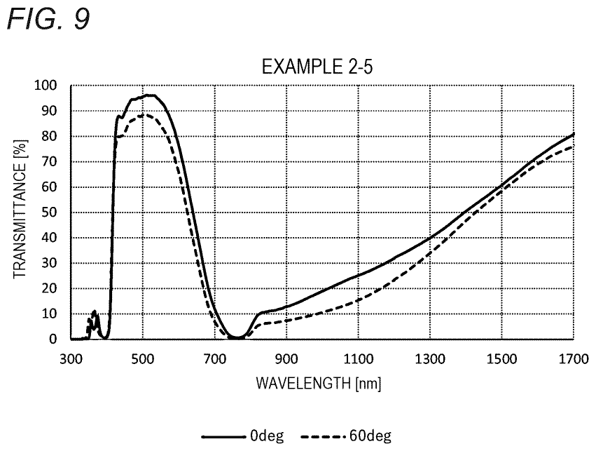

Spectral transmittance curves and spectral reflectance curves of the optical filter of Example 2-1 are shown in FIG. 4 and FIG. 5, respectively. Spectral transmittance curves of the optical filter of Example 2-2 are illustrated in FIG. 6. Spectral transmittance curves of the optical filter of Example 2-3 are illustrated in FIG. 7. Spectral transmittance curves of the optical filter of Example 2-4 are illustrated in FIG. 8. Spectral transmittance curves of the optical filter of Example 2-5 are illustrated in FIG. 9.

Examples 2-1 to 2-4 are inventive examples, and Examples 2-5 and 2-6 are comparative examples.

TABLE 6

| | Example | Example | Example | Example | Example | Example |
|---|---|---|---|---|---|---|
| Optical filter | 2-1 | 2-2 | 2-3 | 2-4 | 2-5 | 2-6 |
| 450-600 nm, 0 deg average transmittance (%) | 91.66 | 92.07 | 91.79 | 91.00 | 91.87 | 91.05 |
| 450-600 nm, 60 deg average transmittance (%) | 82.93 | 83.38 | 83.04 | 82.18 | 83.19 | 76.41 |
| \|450-600 nm, 0 deg average transmittance - 450 | 8.73 | 8.69 | 8.75 | 8.82 | 8.68 | 14.64 |
| 600 nm, 60 deg average transmittance \| (%) | | | | | | |
| 550-650 nm, 0 deg average transmittance (%) | 73.3 | 74.2 | 75.7 | 74.2 | 73.0 | 72.7 |
| 550-650 nm, 60 deg average transmittance (%) | 62.78 | 63.73 | 65.24 | 63.63 | 62.64 | 49.36 |
| 700-750 nm, 0 deg average transmittance (%) | 4.5 | 4.2 | 2.7 | 3.4 | 5.2 | 2.1 |
| Wavelength IR(0 deg)80 at which transmittance at | 593 | 595 | 600 | 596 | 592 | 592 |
| 0 deg is 80% (nm) | | | | | | |
| Wavelength IR(0 deg)20 at which transmittance at | 681 | 680 | 677 | 679 | 682 | 681 |
| 0 deg is 20% (nm) | | | | | | |
| \|IR80(0 deg)-IR20(0 deg)\| (nm) | 88 | 85 | 77 | 83 | 90 | 89 |
| Wavelength IR(0 deg)50 at which transmittance at | 640 | 640 | 642 | 641 | 639 | 638 |
| 0 deg is 50% (nm) | | | | | | |
| Wavelength IR(60 deg)50 at which transmittance | 624 | 625 | 628 | 626 | 624 | 602 |
| at 60 deg is 50% (nm) | | | | | | |
| \|IR50(0 deg)-IR50(60 deg)\| (nm) | 16 | 15 | 14 | 15 | 15 | 36 |
| 800-1,200 nm, 0 deg average transmittance (%) | 4.6 | 3.4 | 0.2 | 0.9 | 19.1 | 0.4 |
| 1,200-1,700 nm, 0 deg average transmittance (%) | 33.82 | 31.61 | 15.98 | 21.36 | 55.80 | 50.49 |
| 750-1,200 nm, 0 deg maximum transmittance (%) | 9.93 | 7.95 | 0.95 | 2.51 | 31.79 | 3.13 |
| 750-1,200 nm, 60 deg, maximum transmittance (%) | 5.55 | 4.25 | 0.31 | 1.02 | 23.24 | 25.05 |
| 1,000-1,200 nm, 0 deg maximum transmittance (%) | 9.93 | 7.95 | 0.95 | 2.51 | 31.79 | 3.13 |
| 1,000-1,200 nm, 60 deg maximum transmittance (%) | 5.55 | 4.25 | 0.31 | 1.02 | 23.24 | 25.05 |
| 450-600 nm, 5 deg maximum transmittance on | 1.35 | 1.35 | 1.34 | 1.33 | 1.35 | 3.75 |
| dielectric multilayer film 1 side (%) | | | | | | |
| 450-600 nm, 5 deg maximum transmittance on | 1.33 | 1.33 | 1.32 | 1.32 | 1.33 | 3.50 |
| dielectric multilayer film 2 side (%) | | | | | | |
| 900-1,000 nm, 0 deg average transmittance (%) | 3.01 | 2.04 | 0.07 | 0.38 | 15.68 | 0.00 |

Based on the above results, the optical filters of Examples 2-1 to 2-4 have high transmittance in the visible light region and high shielding properties in the near-infrared region over a wide range of 700 nm to 1,200 nm and 1,200 nm to 1,700 nm. Since the absolute value of the difference between the wavelength IR_{80(0deg)} and the wavelength IR_{20(0deg)} is 90 nm or less, it is understood that the optical filter is an optical filter in which the change in transmittance from the visible light transmission region to the near-infrared light shielding region is steep. Further, since the absolute value of the difference between the wavelength IR_{50(0deg)} and the wavelength IR_{50(60deg)} is 30 nm or less, a grazing incidence shift are less likely to occur.

On the other hand, in the optical filters of Examples 2-5 and 2-6, shielding properties in a near-infrared region of 1,200 nm to 1,700 nm was small. The reason for this is considered to be that the near-infrared ray absorbing glass used in Examples 2-5 and 2-6 cannot sufficiently absorb light in such a region. In the optical filter of Example 2-6, one of the dielectric multilayer films is a reflection layer and was difficult to shield light of the region of 1,200 nm to 1,700 nm by reflection. Further, in the optical filter of Example 2-5, an average transmittance in a range of 800 nm to 1,200 nm and an average transmittance in a range of 700 nm to 750 nm were high, and shielding properties in such regions were also low.

Since the dielectric multilayer film 2 in the optical filter of Example 2-6 is a reflection layer of near-infrared light, it is understood that at a high incident angle, a transmittance at 550 nm to 650 nm is reduced, the absolute value of the difference between the wavelength IR_{50(0deg)} and the wavelength IR_{50(60deg)} exceeds 30 nm, and a grazing incidence shift is likely to occur in the optical filter.

Although the present invention has been described in detail with reference to specific embodiments, it is apparent to those skilled in the art that various changes and modifications can be made without departing from the spirit and scope of the present invention. The present application is based on a Japanese Patent Application (Japanese Patent Application No. 2022-138365) filed on Aug. 31, 2022, the contents of which are incorporated herein by reference.

### INDUSTRIAL APPLICABILITY

The optical filter of the present invention has spectral characteristics including a small change in spectral characteristics even at a high incident angle, excellent transmittance in the visible light region, a steep change in transmittance from the visible light transmission region to the near-infrared light shielding region, and excellent shielding properties in the near-infrared light region, in particular, shielding properties in a wide range also including 1,200 nm to 1,700 nm. In recent years, the optical filter is useful for applications of imaging devices such as cameras and sensors for transport machines, for which high performance has been achieved.

### REFERENCE SIGNS LIST

1: optical filter

A1: dielectric multilayer film

A2: dielectric multilayer film

11: near-infrared ray absorbing glass

12: resin film

1. An optical filter satisfying all of the following spectral characteristics (i-1) to (i-8):
(i-1) an average transmittance T_{450-600(0deg)AVE} at a wavelength of 450 nm to 600 nm and an incident angle of 0 degrees is 90% or more
(i-2) an average transmittance T_{550-650(0deg)AVE} at a wavelength of 550 nm to 650 nm and an incident angle of 0 degrees is 70% or more
(i-3) an average transmittance T_{550-650(60deg)AVE} at a wavelength of 550 nm to 650 nm and an incident angle of 60 degrees is 50% or more
(i-4) an average transmittance T_{700-750(0deg)AVE} at a wavelength of 700 nm to 750 nm and an incident angle of 0 degrees is 5% or less
(i-5) in a wavelength of 500 nm to 700 nm, an absolute value of a difference between a wavelength IR_{80(0deg)} at which a transmittance is 80% at an incident angle of 0 degrees and a wavelength IR_{20(0deg)} at which a transmittance is 20% at an incident angle of 0 degrees is 90 nm or less
(i-6) in a wavelength of 500 nm to 700 nm, a wavelength IR_{50(0deg)} at which a transmittance is 50% at an incident angle of 0 degrees and a wavelength IR_{50(60deg)} at which a transmittance is 50% at an incident angle of 60 degrees are both in a wavelength region of 600 nm to 660 nm, and an absolute value of a difference between the wavelength IR_{50(0deg)} and the wavelength IR_{50(60deg)} is 30 nm or less
(i-7) an average transmittance T_{800-1200(0deg)AVE} at a wavelength of 800 nm to 1,200 nm and an incident angle of 0 degrees is 15% or less
(i-8) an average transmittance T_{1200-1700(0deg)AVE} at a wavelength of 1,200 nm to 1,700 nm and an incident angle of 0 degrees is 50% or less.

2. The optical filter according to claim 1,
wherein the optical filter comprises a dielectric multilayer film 1, a resin film, a near-infrared ray absorbing glass, and a dielectric multilayer film 2 in this order,
the resin film comprises a resin and a near-infrared ray absorbing dye having a maximum absorption wavelength in 690 nm to 800 nm in the resin, and
the resin film has a thickness of 10 μm or less.

3. The optical filter according to claim 2, wherein the near-infrared ray absorbing glass has a Vickers hardness of 420 kgf/mm² or less.

4. The optical filter according to claim 2, wherein the near-infrared ray absorbing glass satisfies the following spectral characteristic (ii-1):
(ii-1) in a wavelength of 500 nm to 700 nm, an absolute value of a difference between a wavelength λ₈₀ at which an internal transmittance is 80% and a wavelength λ₂₀ at which an internal transmittance is 20% is 130 nm or less.

5. The optical filter according to claim 2, wherein the near-infrared ray absorbing glass satisfies the following spectral characteristic (ii-2):
(ii-2) an average internal transmittance T_{(in)1200-1700AVE} at a wavelength of 1,200 nm to 1,700 nm is 70% or less.

6. The optical filter according to claim 2, wherein when an internal transmittance of the near-infrared ray absorbing glass at a wavelength of 380 nm is defined as T₍ᵢₙ₎₃₈₀, an internal transmittance of the near-infrared ray absorbing glass at a wavelength of 550 nm is defined as T₍ᵢₙ₎₅₅₀, and an internal transmittance of the near-infrared ray absorbing glass at a wavelength of 950 nm is defined as T₍ᵢₙ₎₉₅₀, the following spectral characteristics (ii-3) to (ii-5) are all satisfied:
$$( ii - 3 ) {T}_{( in ) 380} / {T}_{( in ) 950} \geq 10$$
$$( ii - 4 ) {T}_{( in ) 550} / {T}_{( in ) 950} \geq 10$$
$$( ii - 5 ) {T}_{( in ) 380} / {T}_{( in ) 550} \leq 2 .$$

7. The optical filter according to claim 1, further satisfying the following spectral characteristics (i-9) and (i-10):
(i-9) a maximum transmittance T_{750-1200(0deg)MAX} at a wavelength of 750 nm to 1,200 nm and an incident angle of 0 degrees is 30% or less
(i-10) a maximum transmittance T_{750-1200(60deg)MAX} at a wavelength of 750 nm to 1,200 nm and an incident angle of 60 degrees is 30% or less.

8. The optical filter according to claim 1, further satisfying the following spectral characteristics (i-11) to (i-14):
(i-11) an average transmittance T_{450-600(60deg)AVE} at a wavelength of 450 nm to 600 nm and an incident angle of 60 degrees is 80% or more
(i-12) an absolute value of a difference between the average transmittance T_{450-600(0deg)AVE} and the average transmittance T_{450-600(60deg)AVE} is 10% or less
(i-13) a maximum transmittance T_{1000-1200(0deg)MAX} at a wavelength of 1,000 nm to 1,200 nm and an incident angle of 0 degrees is 30% or less
(i-14) a maximum transmittance T_{1000-1200(60deg)MAX} at a wavelength of 1,000 nm to 1,200 nm and an incident angle of 60 degrees is 20% or less.

9. The optical filter according to claim 1, further satisfying the following spectral characteristics (i-15) and (i-16):
(i-15) when a dielectric multilayer film 1 side is set as an incident direction, a maximum reflectance R1_{450-600(5deg)MAX} at a wavelength of 450 nm to 600 nm and an incident angle of 5 degrees is 3% or less
(i-16) when a dielectric multilayer film 2 side is set as an incident direction, a maximum reflectance R2_{450-600(5deg)MAX} at a wavelength of 450 nm to 600 nm and an incident angle of 5 degrees is 3% or less.

10. The optical filter according to claim 1, further satisfying the following spectral characteristic (i-17):
(i-17) an average transmittance T_{900-1000(0deg)AVE} at a wavelength of 900 nm to 1,000 nm and an incident angle of 0 degrees is 10% or less.

11. The optical filter according to claim 2, wherein the near-infrared ray absorbing glass comprises, in terms of mass % based on oxide,
40% to 85% of P₂O₅,
0.5% to 20% of Al₂O₃,
0.5% to 20% of ΣR₂O (where R₂O is one or more components selected from Li₂O, Na₂O, K₂O, Rb₂O, and Cs₂O, and ΣR₂O is a total content of R₂O),
0% to 40% of ΣR′O (where R′O is one or more components selected from CaO, MgO, BaO, SrO, and ZnO, and ΣR′O is a total content of R′O), and
0.5% to 40% of CuO.

12. An imaging device comprising the optical filter according to claim 1.
